(19) United States
(12) Patent Application Publication
(10) Pub. No.: US 2009/0063997 A1
(43) Pub. Date: Mar. 5, 2009

(54) METHOD AND SYSTEM FOR RETAINING LINKING PAGES THROUGH A BROWSER SESSION

(76) Inventors: Indran Naick, Cedar Park, TX (US); Jeffrey K. Wilson, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/845,558

(22) Filed: Aug. 27, 2007

(51) Int. Cl. G06F 3/01

(52) U.S. Cl. 715/760

(57) ABSTRACT

A method of retaining linking pages through a browser session. A browser window presents a first web page that includes one or more links. A user marks the first web page in as a “thumbtacked” web page. A thumbtack utility iteratively determines whether or not a graphical cursor is in proximity to a link among one of the one or more links included in the first web page. When the cursor is in close proximity to one of the links, the thumbtack utility displays a hidden pane in a first portion of the browser window. The hidden pane includes data from a second web page corresponding to the link. The browser also displays the first web page concurrently in a second portion of the browser window. When the cursor is not in close proximity to one of the links, the thumbtack utility removes the hidden pane from view.

### BACKGROUND OF THE INVENTION

1. Technical Field

The present invention relates in general to computers and in particular to internet browser applications. Still more particularly, the present invention relates to an improved method and system for retaining linking pages through a browser session.

2. Description of the Related Art

A web browser is a software application that enables a computer user to view text, images, and other multi-media information located on one or more web pages. Computer users access web pages via the World Wide Web or a Local Area Network (LAN). A web browser typically includes a Graphical User Interface (GUI) that enables a user to view multiple web pages in different windows and/or to launch multiple web pages from links included on a single source page. For example, a user may view a web page from a list of links on an internet search results page then subsequently return to the search results page and click on a different link to view another web page.

Conventional methods of viewing multiple web pages during a single browser session typically involve a user manually launching each new web page into a new window. For example, a user must right click on a link in a parent page and select an option to open a link to a child page in a new window if the user wants to view the child page without navigating past the parent page. Launching multiple child web pages spawned from a parent web page also creates numerous windows and may cause clutter on a user's desktop and/or window tab bar.

### SUMMARY OF AN EMBODIMENT

Disclosed are a method, system, and computer program product for retaining linking pages through a browser session. A method of retaining linking pages through a browser session. A browser window presents a first web page that includes one or more links. A user marks the first web page in as a “thumbtacked” web page. A thumbtack utility iteratively determines whether or not a graphical cursor is in proximity to a link among one of the one or more links included in the first web page. When the cursor is in close proximity to one of the links, the thumbtack utility displays a hidden pane in a first portion of the browser window. The hidden pane includes data from a second web page corresponding to the link. The browser also displays the first web page concurrently in a second portion of the browser window. When the cursor is not in close proximity to one of the links, the thumbtack utility removes the hidden pane from view, and the browser displays the first web page in both the first and second portions of the browser window.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary computer, according to an embodiment of the present invention;

FIG. 2A illustrates an exemplary browser displaying search results, according to an embodiment of the present invention;

FIG. 2B illustrates an exemplary auto-hide pane displayed in the browser of FIG. 2A, according to an embodiment of the present invention; and

FIG. 3 is a high level logical flowchart of an exemplary method of retaining linking pages through a browser session, according to an embodiment of the invention.

### DETAILED DESCRIPTION OF AN ILLUSTRATIVE EMBODIMENT

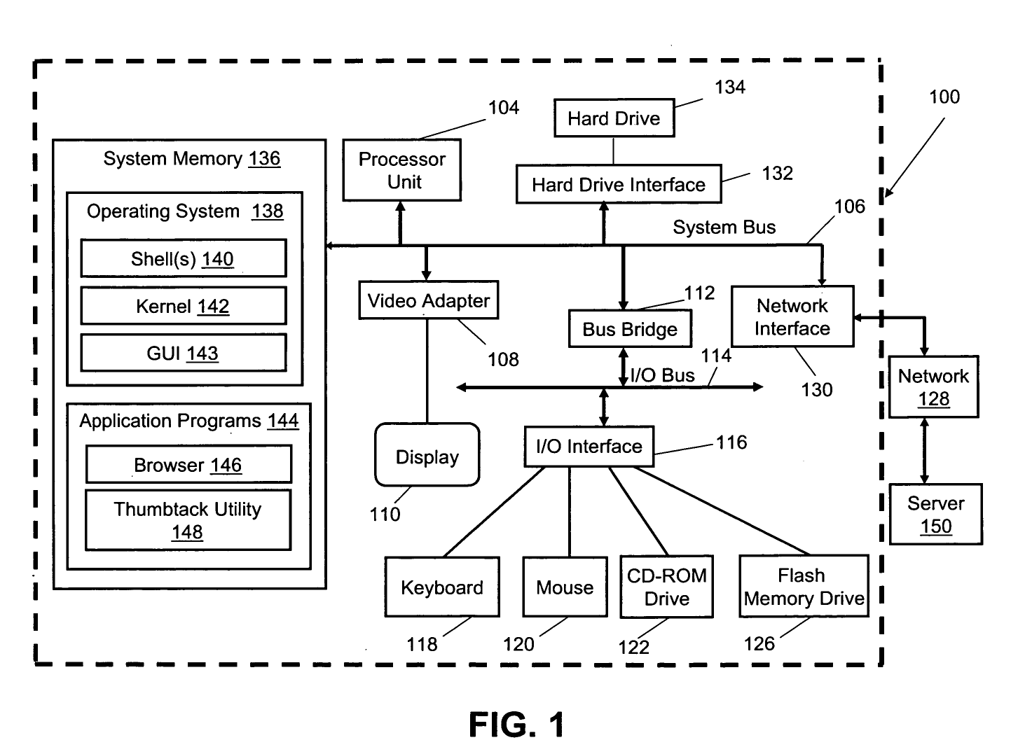

With reference now to FIG. 1, there is depicted a block diagram of an exemplary computer 100, with which the present invention may be utilized. Computer 100 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk-Read Only Memory (CD-ROM) drive 122, and flash memory drive 126. The format of the ports connected to I/O interface 116 may be any known to those skilled in the art of computer architecture, including but not limited to Universal Serial Bus (USB) ports.

Computer 100 is able to communicate with server 150 via network 128 using network interface 130, which is coupled to system bus 106. Network 128 may be an external network such as the Internet, or an internal network such as a Local Area Network (LAN), an Ethernet, or a Virtual Private Network (VPN). In one embodiment, server 150 is configured similarly to computer 100.

Hard drive interface 132 is also coupled to system bus 106. Hard drive interface 132 interfaces with hard drive 134. In one embodiment, hard drive 134 populates system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Data that populates system memory 136 includes Operating System (OS) 138 and application programs 144.

OS 138 includes shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes graphical user interface (GUI) 143 and kernel 142, which includes lower levels of functionality for OS 138. Kernel 142 provides essential services required by other parts of OS 138 and application programs 144. The services provided by kernel 142 include memory management, process and task management, disk management, and I/O device management.

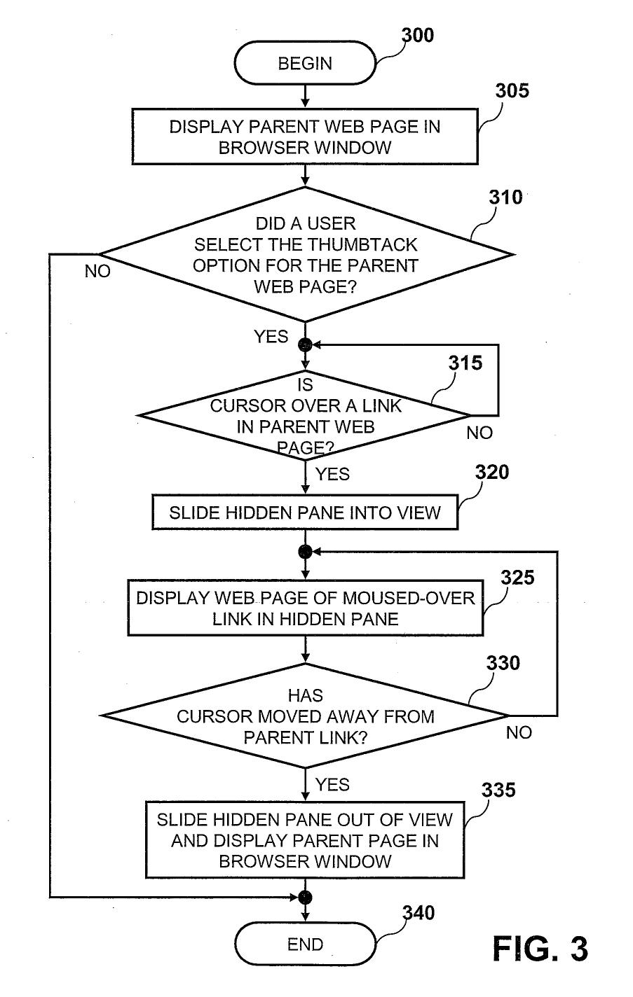

Application programs 144 include browser 146 and thumbtack utility 148. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Thumbtack utility 148 performs the functions illustrated in FIG. 3, which is discussed below. Although illustrated separately from browser 146 for clarity, in some embodiments thumbtack utility 148 may be implemented as a portion of browser 146 or as a plug-in for browser 146, as is known in the art.

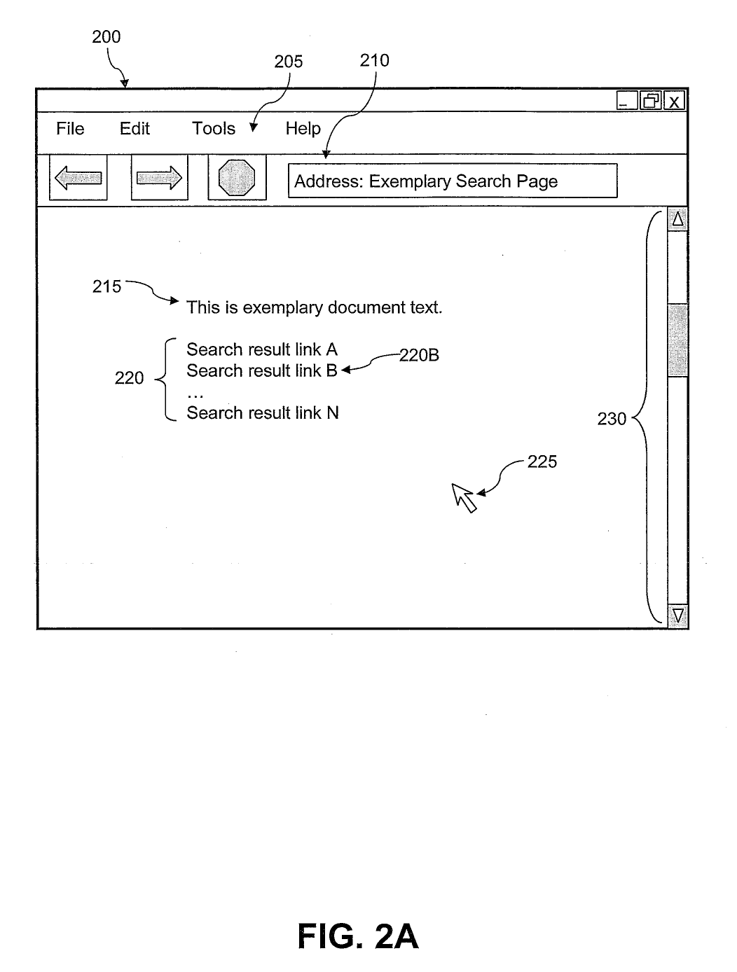

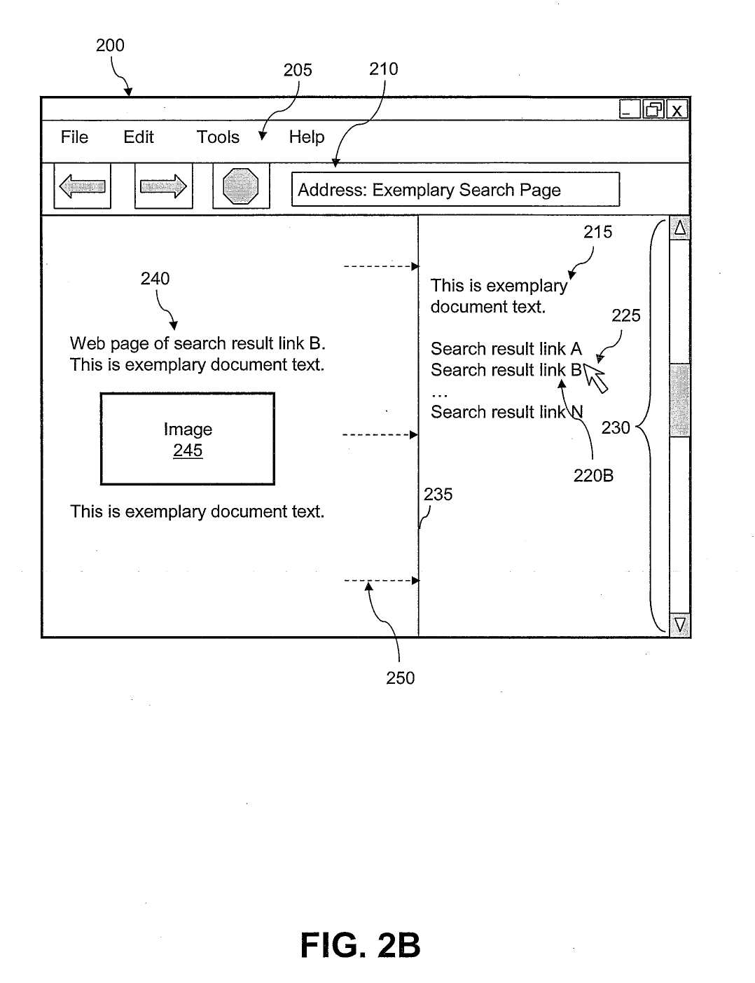

With reference now to FIG. 2A, there is depicted an exemplary graphical user interface of a browser displaying search results, according to an embodiment of the present invention. As shown, browser 146 includes a display window 200, a window control bar 205, and a web navigation bar 210. Window control bar 205 includes one or more pull down menus (e.g., a “file” menu). Similarly, web navigation bar 210 includes multiple GUI buttons and/or an internet address field. Browser 146 displays document text 215 and/or multiple search result links 220A through 220N, where N is a positive integer. A user of browser 146 may view a web page corresponding to one of search result links 220A-220N by using a cursor 225 to click on a particular link. In one embodiment, a user of browser 146 may view multiple pages of text and/or images in a web page by using a scroll bar 230.

As shown in FIG. 2A, cursor 225 is not located in close proximity to any of links 220A-220N. Therefore, an auto-hide pane is hidden from view. According to the illustrative embodiment, an auto-hide pane that includes text and/or images of a web page corresponding to a link will automatically remain hidden until a user of browser 146 relocates cursor 225 in proximity to and, in one embodiment, “mouses over” one of search result links 220A-220N, as shown in FIG. 2B, which is discussed below. As utilized herein, a “mouse over” refers to a movement of mouse 120 (FIG. 1) that causes cursor 225 to enter a pre-defined area within close proximity to a web page link.

In one embodiment, a user of browser 146 must first activate an option within browser 146, GUI 143 and/or thumbtack utility 148 to “thumbtack” a parent web page and thereby enable a hidden pane that includes a child web page to be automatically displayed in response to a mouse over of a child link on the parent web page. As utilized herein, “thumbtacking” refers to using an option in browser 146, GUI 143 and/or thumbtack utility 148 to mark a parent web page that includes one or more links to child web pages, thereby enabling thumbtack utility 148 to automatically return to the thumbtacked page when a user has finished viewing a child web page in a hidden pane (e.g., after a child link is no longer moused-over).

With reference now to FIG. 2B, there is depicted an exemplary auto-hide pane displayed in the graphical user interface (GUI) of browser 146 (FIG. 1), according to an embodiment of the present invention. As shown, cursor 225 is positioned in close proximity to search result link 220B (e.g., a user has performed a “mouse over” of search result link B), and a hidden pane 235 is visible on the left side of the viewing area within the same window as the original document text 215 (FIG. 2A), which is displayed simultaneously on the right side of the window. Hidden pane 235 includes text 240 and/or images 245 of a web page that corresponds to search result link 220B. In one embodiment, the display of hidden pane 235 is animated so that hidden pane 235 gradually slides into view to occupy a pre-defined portion of the viewing area of the GUI of browser 146. This animation is indicated in FIG. 2B by arrows 250. In an alternate embodiment, hidden pane 235 may suddenly become visible within a pre-defined portion of the viewing area of browser 146. In another embodiment, a customizable user-defined setting may enable an auto-hide window to appear in a new window/tab or to replace the current window/tab.

Turning now to FIG. 3, there is illustrated a high level logical flowchart of an exemplary method of retaining linking pages through a browser session, according to an embodiment of the invention. The process begins at block 300 and then proceeds to block 305. Block 305 depicts a user of computer 100 (FIG. 1) invoking the display of a parent web page containing one or more links within a window of browser 146, for example, by utilizing conventional navigation and/or search techniques to navigate to the parent web page (e.g., a search results page containing one or more “hits”). At block 310, thumbtack utility 148 determines whether a user has selected an option in thumbtack utility 148, browser 146 and/or GUI 143 to thumbtack the displayed list of search result links. If a user of browser 146 did not select the option to thumbtack the current parent web page, the process shown in FIG. 3 terminates at block 340.

If, on the other hand, a user of browser 146 has selected the option to thumbtack the parent web page, thumbtack utility 148 determines whether cursor 225 is currently in close proximity to a child web page link on the thumbtacked parent web page, as shown in block 315. If cursor 225 is not currently positioned in close proximity to a child web page link (e.g., the user has not moused-over a link), the process returns to block 315 until a user mouses-over a link or navigates to a new parent web page.

If, on the other hand, thumbtack utility 146 determines that cursor 225 is positioned in proximity to (e.g., over) a child web page link on the thumbtacked parent web page, thumbtack utility 148 slides hidden pane 235 (FIG. 2B) into view within the window of browser 146 containing the parent web page, as depicted in block 320. Browser 146 displays text 240 and/or images 245 of the web page corresponding to the moused-over child link in hidden pane 235, as shown in block 325. In one embodiment, the original document text 215 remains visible within the browser window while hidden pane 235 is visible. In another embodiment, a user may press one or more “hot keys” on keyboard 118 to trigger thumbtack utility 148 to display hidden pane 235.

At block 330, thumbtack utility 148 determines whether cursor 225 has moved out of a predetermined proximity from the child web page link. If cursor 225 is still in close proximity to the web page link corresponding to the child web page, the process returns to block 325. If, however, thumbtack utility 148 determines that cursor 225 has been moved out of the predetermined proximity from the child web page link corresponding to the child web page displayed in hidden pane 235, thumbtack utility 148 automatically slides hidden pane 235 out of view, and browser 146 displays the parent web page in the full viewing area of browser 146, as shown in block 335. The process subsequently terminates at block 340 unless a user mouses-over another child web page link within the parent web page.

In one embodiment, a user may also click on a “moused over” link in order to cause hidden pane 235 to remain visible. For example, a user may first click on a “moused over” link in order cause hidden pane 235 to remain visible, and then the user may move cursor 225 away from the “moused over” link and subsequently click on one or more links on the child web page. In an alternate embodiment, if a user clicks on a “moused over” link, hidden pane 235 may temporarily remain visible for a pre-defined period of time before automatically sliding out of view. In another embodiment, a user may use mouse 120 to move cursor 225 to one side of display window 200 (e.g., the left side of display window 200) to manually trigger thumbtack utility 148 to slide hidden pane 235 out of view and/or enable browser 146 to redisplay the parent web page. In yet another embodiment, a user may press one or more pre-defined “hot keys” on keyboard 118 to cycle through one or more additional pages displayed in hidden pane 235 (e.g., a user may press a “next” hot key to flip to the contents of a second window tab in hidden pane 235).

The present invention thus provides a method of retaining linking pages through a browser session. A user marks a first web page in browser 146 (FIG. 1) as a thumbtacked web page. The thumbtacked parent web page includes one or more links 220 (FIG. 2A) to different child web pages. When the web page currently displayed in the browser is a thumbtacked web page and cursor 225 is in close proximity to one of links 220 included, thumbtack utility 148 displays hidden pane 235 (FIG. 2B) in a portion of a window of the browser. Hidden pane 235 includes data of a second web page corresponding to the “moused over” link. Browser 146 also displays the first web page concurrently in a remaining portion of the same window. When cursor 225 is not in close proximity to one of links 220 included in the first web page, thumbtack utility 148 removes hidden pane 235 from view, and browser 146 displays the first web page in the entire display area of a window 200.

It is understood that the use herein of specific names are for example only and not meant to imply any limitations on the invention. The invention may thus be implemented with different nomenclature/terminology and associated functionality utilized to describe the above devices/utility, etc., without limitation.

In the flow chart (FIG. 3) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. In a computer system, a method comprising:
presenting a first web page in a browser window, said first web page including one or more links;
receiving an input identifying the first web page as a thumbtacked web page;
iteratively determining whether or not a graphical cursor is in proximity to a link among of the one or more links included in said first web page;
in response to a determination that the cursor is in proximity to a link among of the one or more links included in said first web page:
displaying a hidden pane in a first portion of the browser window, wherein said hidden pane contains data from a second web page corresponding to said link; and
displaying said first web page concurrently in a second portion of the browser window.

2. The method of claim 1, and further comprising removing said hidden pane from view and displaying said first web page in both the first and second portions of said browser window in response to a determination that said cursor is not in close proximity to one of said one or more links included in said first web page.

3. The method of claim 1, wherein iteratively determining whether or not the graphical cursor is in proximity to a link among the one or more links comprises determining whether said cursor has been placed within a predetermined region of the link.

4. A computer system comprising:
a processor unit;
data storage coupled to said processor unit; and
program code within the data storage that provides the functions of:
presenting a first web page in a browser window, said first web page including one or more links;
receiving an input identifying the first web page as a thumbtacked web page;
iteratively determining whether or not a graphical cursor is in proximity to a link among of the one or more links included in said first web page;
in response to a determination that the cursor is in proximity to a link among of the one or more links included in said first web page:
displaying a hidden pane in a first portion of the browser window, wherein said hidden pane contains data from a second web page corresponding to said link; and
displaying said first web page concurrently in a second portion of the browser window.

5. The computer system of claim 3, and further comprising means for removing said hidden pane from view and displaying said first web page in both the first and second portions of said browser window in response to a determination that said cursor is not in close proximity to one of said one or more links included in said first web page.

6. The computer system of claim 3, wherein iteratively determining whether or not the graphical cursor is in proximity to a link among the one or more links comprises means for determining whether said cursor has been placed within a predetermined region of the link.

7. A computer program product comprising:
a computer storage medium; and
program code on said computer storage medium that that when executed provides the functions of:
presenting a first web page in a browser window, said first web page including one or more links;
receiving an input identifying the first web page as a thumbtacked web page;
iteratively determining whether or not a graphical cursor is in proximity to a link among of the one or more links included in said first web page;
in response to a determination that the cursor is in proximity to a link among of the one or more links included in said first web page:
displaying a hidden pane in a first portion of the browser window, wherein said hidden pane contains data from a second web page corresponding to said link; and
displaying said first web page concurrently in a second portion of the browser window.
